(19) United States
(12) Patent Application Publication
(10) Pub. No.: US 2026/0276209 A1
(43) Pub. Date: Sep. 17, 2026

(54) FILTER UNIT, MANUFACTURING METHOD THEREOF, AND COOKING APPARATUS INCLUDING FILTER UNIT

(71) Applicant: SAMSUNG ELECTRONICS CO., LTD., Suwon-si (KR)

(72) Inventors: Jeeyong KIM, Suwon-si (KR); Duckjin SUNG, Suwon-si (KR); Yujeub HA, Suwon-si (KR); Kisup LEE, Suwon-si (KR)

(73) Assignee: SAMSUNG ELECTRONICS CO., LTD., Suwon-si (KR)

(21) Appl. No.: 19/673,706

(22) Filed: May 11, 2026

Related U.S. Application Data
(63) Continuation of application No. PCT/KR2024/016250, filed on Oct. 24, 2024.

(30) Foreign Application Priority Data
Dec. 15, 2023 (KR) 10-2023-0183713

(51) Int. Cl. F24C 15/20; B01D 39/10; B01D 46/00; B01D 46/56

(52) U.S. Cl. CPC F24C 15/2042; B01D 39/10; B01D 46/0038; B01D 46/56; F24C 15/2035

(57) ABSTRACT

A cooking apparatus includes a plate including a cooking zone and an intake port to allow air to be introduced toward the cooking zone. In addition, the cooking apparatus includes a chamber housing to be disposed on a lower side of the plate and forming a chamber through which air flows. In addition, the cooking apparatus includes a filter unit disposed in the chamber and configured to filter air introduced through the intake port. The filter unit includes a frame that allows a plurality of cells to be stacked along a first direction of the frame and be arranged along a second direction of the frame intersecting the first direction and a deodorizing agent to be accommodated inside the plurality of cells. The plurality of cells respectively has a length along the first direction shorter than a length along the second direction.

### CROSS-REFERENCE TO RELATED APPLICATION

This application is a continuation application, under 35 U.S.C. §111(a), of international application No. PCT/KR2024/016250, filed October 24, 2024, which claims priority under 35 U. S. C. §119 to Korean Patent Application No. 10-2023-0183713, filed December 15, 2023, the disclosures of which are incorporated herein by reference in their entireties.

### TECHNICAL FIELD

The disclosure relates to a filter unit with an improved structure, a method of manufacturing the same, and a cooking apparatus comprising the filter unit with the improved structure.

### BACKGROUND ART

A cooking apparatus is an appliance that heats and cooks an object to be cooked, such as food, and is capable of providing various functions related to cooking, such as heating, defrosting, drying, and sterilizing the object to be cooked. A cooking apparatus may include a cooktop that heats a cooking vessel containing food using electricity or gas.

A gas cooktop, which is a device that uses gas, is a gas stove that ignites and combusts gas from a small generator by turning a lever, and cooks food with the generated heat.

An electric cooktop, which is a device that uses electricity, is an induction heating device that generates an electromagnetic field in an internal coil using electricity, induces an eddy current in a cooking vessel according to the principle of electromagnetic induction to generate heat, and cooks food with the heat.

In the case of a cooktop, pollutants such as oil mist, unburned gases, and odors may be generated during the process of cooking food. A hood may be provided to discharge air containing such pollutants to the outside.

### Disclosure

### Technical Problem

An embodiment of the present disclosure provides a cooking apparatus with improved deodorization performance of a filter unit.

An embodiment of the present disclosure provides a cooking apparatus with an extended lifespan of a filter unit.

Technical tasks to be achieved in this document are not limited to the technical tasks mentioned above, and other technical tasks not mentioned will be clearly understood by those skilled in the art from the description below.

### Technical Solution

A cooking apparatus according to the concept of the present disclosure includes a plate including a cooking zone and an intake port to allow air to be introduced toward the cooking zone. In addition, the cooking apparatus includes a chamber housing to be disposed on a lower side of the plate and forming a chamber through which air flows. In addition, the cooking apparatus includes a filter unit disposed in the chamber and configured to filter air introduced through the intake port. The filter unit includes a frame that allows a plurality of cells to be stacked along a first direction of the frame and be arranged along a second direction of the frame intersecting the first direction and a deodorizing agent accommodated inside the plurality of cells. The plurality of cells respectively has a length along the first direction shorter than a length along the second direction.

A cooking apparatus according to the concept of the present disclosure includes a plate including an intake port, and a filter unit disposed below the plate and configured to filter air entering through the intake port. The filter unit includes a frame including a plurality of cells, a first filter coupled to a front of the frame, and a second filter coupled to a rear of the frame. The plurality of cells may be stacked in a first direction of the frame and arranged in a second direction intersecting the first direction. The plurality of cells respectively has a length along the first direction shorter than a length along the second direction.

A manufacturing method of a filter unit according to the concept of the present disclosure includes: injection-molding a frame in which a plurality of cells are formed; inserting a non-woven fabric during the injection molding of the frame to couple the non-woven fabric to a rear surface of the frame; filling a deodorizing agent into each of the plurality of cells; and coupling a mesh net to a front surface of the frame using a thermal fusion method. The filter unit is provided inside a cooking apparatus to filter air introduced from the surroundings of the cooking apparatus.

### DESCRIPTION OF DRAWINGS

FIG. 1 is a perspective view of a cooking apparatus according to an embodiment of the present disclosure.

FIG. 2 is a bottom perspective view of the cooking apparatus according to an embodiment of the present disclosure.

FIG. 3 is a view of an example of a state in which a plate is removed from the cooking apparatus according to an embodiment of the present disclosure.

FIG. 4 is a schematic exploded view of the cooking apparatus according to an embodiment of the present disclosure.

FIG. 5 is a partial view of an interior of the cooking apparatus according to an embodiment of the present disclosure.

FIG. 6 is a partial view of the interior of the cooking apparatus according to an embodiment of the present disclosure.

FIG. 7 is a schematic cross-sectional view of the cooking apparatus according to an embodiment of the present disclosure.

FIG. 8 is a perspective view of a filter unit according to an embodiment of the present disclosure.

FIG. 9 is an exploded perspective view illustrating a configuration of the filter unit according to an embodiment of the present disclosure.

FIG. 10 is a front view of the filter unit according to an embodiment of the present disclosure.

FIG. 11 is a flowchart illustrating a manufacturing method of a filter unit according to an embodiment of the present disclosure.

FIG. 12 is a front view of a filter unit according to an embodiment of the present disclosure.

FIG. 13 is a front view of a filter unit according to an embodiment of the present disclosure.

FIG. 14 is a front view of a filter unit according to an embodiment of the present disclosure.

### Modes of the Invention

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

The terms “portion”, “part”, “module”, and “member” may be implemented in hardware or software. In accordance with embodiments, a plurality of “portions”, “parts”, “modules”, and ‘members’ may be implemented as a single component, or a single “portion”, “part”, “module”, or “member” may comprise a plurality of components.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

Meanwhile, terms such as “front”, “rear”, “left”, “right”, “upper”, and “lower” used in the following description are defined based on the drawings, but the shape and position of each component are not limited by these terms. For example, a front side may be defined as a +X side, and a rear side may be defined as a -X side. For example, based on the drawings, a right side may be defined as a +Y side, and a left side may be defined as a -Y side. For example, based on the drawings, an upper side may be defined as a +Z side, and a lower side may be defined as a -Z side.

Hereinafter, embodiments according to the present disclosure will be described in detail with reference to the accompanying drawings.

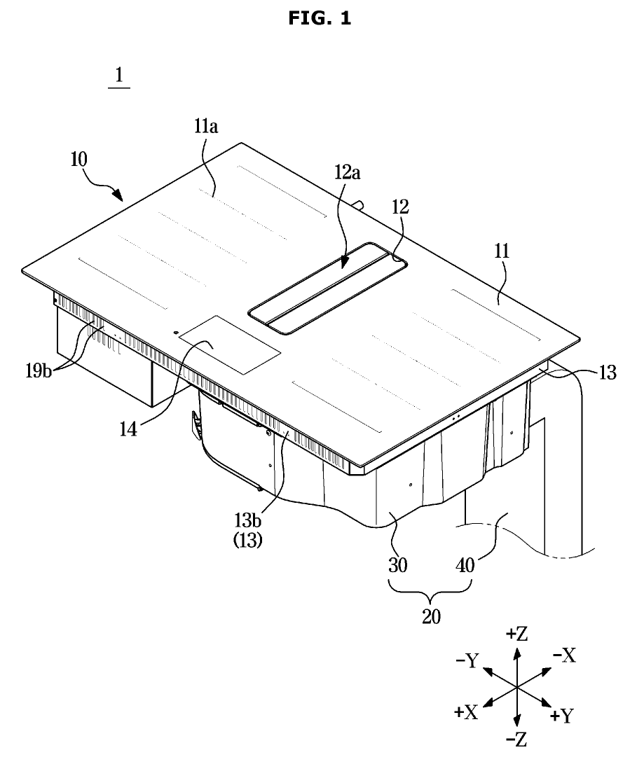

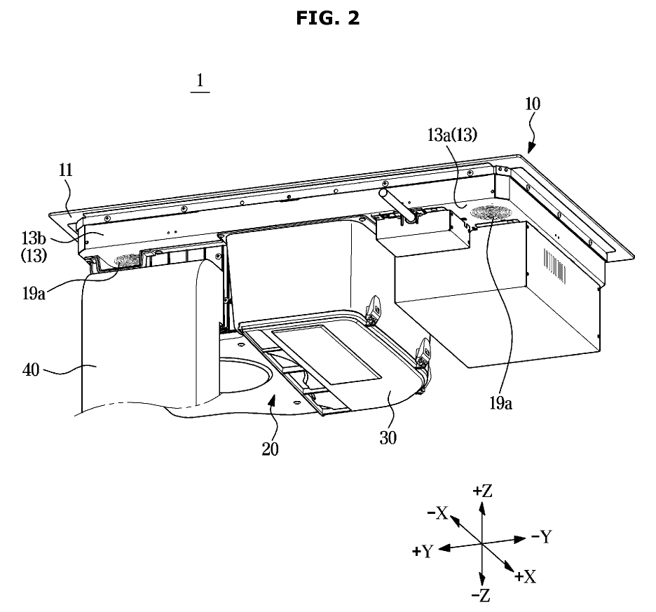

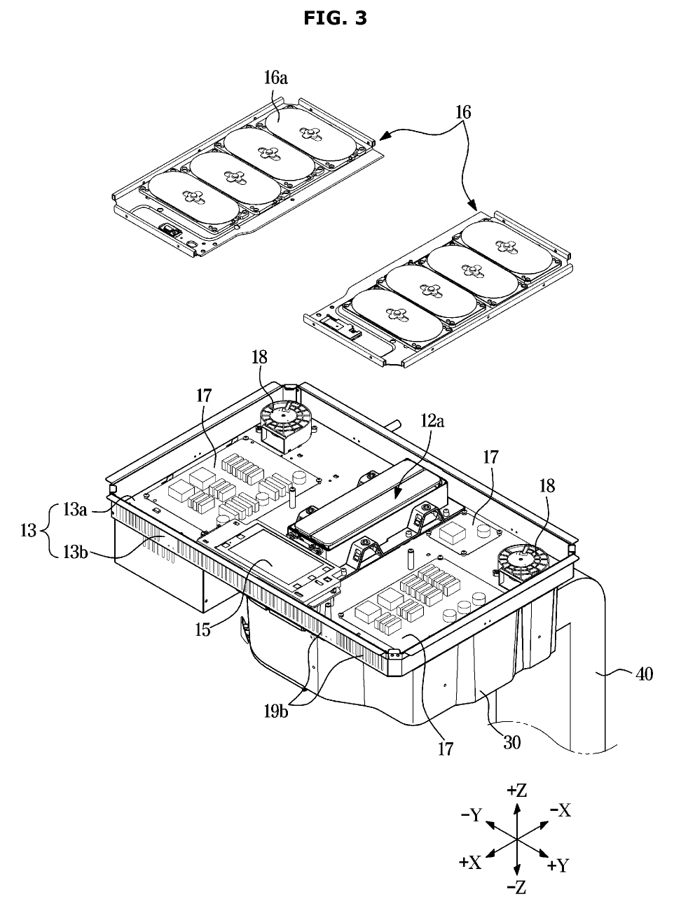

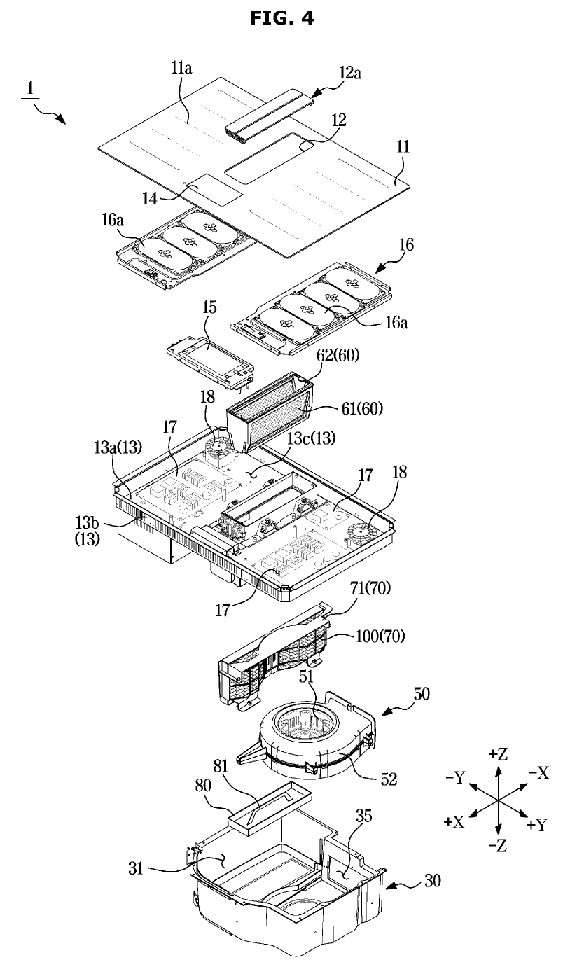

FIG. 1 is a perspective view of a cooking apparatus according to an embodiment of the present disclosure. FIG. 2 is a bottom perspective view of the cooking apparatus according to an embodiment of the present disclosure. FIG. 3 is a view of an example of a state in which a plate is removed from the cooking apparatus according to an embodiment of the present disclosure. FIG. 4 is a schematic exploded view of the cooking apparatus according to an embodiment of the present disclosure.

The cooking apparatus 1 may include a cooktop 10. The cooktop 10 may be configured to cook food. The cooktop 10 may be configured to heat food.

The cooktop 10 may include a plate 11. For example, the plate 11 may include a substantially flat plate shape. For example, the plate 11 may include tempered glass, such as ceramic glass.

The plate 11 may include a cooking zone 11a. A cooking vessel may be placed on the cooking zone 11a to cook food. When food is cooked on the cooking zone 11a, pollutants may be generated and mixed with the air surrounding the cooking zone 11a.

The cooktop 10 may include an intake port 12. The intake port 12 may be formed in the plate 11. The intake port 12 may be configured to penetrate the plate 11. For example, the intake port 12 may be arranged approximately at the center of the plate 11. The intake port 12 may be formed to draw in air around the cooking zone 11a. The intake port 12 may draw in pollutants generated during the cooking process, along with the air surrounding the cooking zone 11a. Here, the pollutants, i.e., cooking-related contaminants may include harmful gases combustion gases, fine dust, oil mist, heat, and/or odors generated during cooking.

The cooktop 10 may include a user interface 14 arranged on the plate 11. The user interface 14 may be configured to receive commands from a user. The user interface 14 may be configured to display various information of the cooking apparatus 1. The user interface 14 may be arranged as an area through which at least a portion of a display assembly 15, which will be described later, is transmitted and visible to the user.

The cooktop 10 may include a case 13. The case 13 may be provided below the plate 11. The case 13 may be coupled to a lower portion of the plate 11.

The case 13 may include a shape having a substantially open upper portion. For example, the case 13 may include a bottom portion 13a and a side portion 13b extending upwardly from the bottom portion 13a.

The case 13 may be configured to accommodate various components constituting the cooktop 10. The case 13 may accommodate electrical components. The case 13 may accommodate the display assembly 15 to be described later. The case 13 may accommodate a heating portion 16, which will be described later. The case 13 may accommodate a printed board assembly (PBA) 17, which will be described later. The case 13 may include a fan 18, which will be described later.

The cooktop 10 may include the display assembly 15. The display assembly 15 may be configured to implement the user interface 14. The display assembly 15 may be arranged to correspond to the user interface 14. For example, the display assembly 15 may be arranged as a PBA including a display panel, switching elements, integrated circuit elements, and the like, and a printed circuit board (PCB) on which the same are installed.

The cooktop 10 may include the heating portion 16. The heating portion 16 may be arranged to generate heat for cooking. For example, the heating portion 16 may include a coil 16a. The coil 16a may be subjected to a current that varies in magnitude over time. As current is applied to the coil 16a, a magnetic field may be formed around the coil 16a. As the current applied to the coil varies, the magnetic field formed around the coil 16a may also vary. An eddy current may flow on the surface of the cooking vessel in contact with the plate 11, and thereby the cooking vessel may be heated.

In the drawings, the cooktop 10 is shown as being induction, an electric cooktop, but the present disclosure is not limited thereto. As long as the cooktop 10 is capable of heating the cooking vessel, the type of the cooktop 10 is not limited. For example, the cooktop 10 may be provided as a gas stove, highlight, hybrid, or oven.

The cooktop 10 may include the PBA 17. The PBA 17 may be configured to supply drive current to the heating portion 16. The PBA 17 may be configured to implement circuitry for operation of the heating portion 16. The PBA 17 may include various elements and/or circuitry for supplying drive current to the heating portion 16.

The cooktop 10 may include the fan 18. The fan 18 may be provided for heat dissipation within the case 13. The fan 18 may blow outside air to reduce the temperature of the PBA 17 and/or the display assembly 15. The fan 18 may draw in outside air. The fan 18 may discharge air that has flowed inside the case 13. Outside air introduced into the case 13 through the fan 18 may cool the interior of the case 13 and then be discharged out of the case 13.

The case 13 may have an intake hole 19a and a discharge hole 19b formed in the case 13. For example, the intake hole 19a may be formed in the bottom portion 13a of the case 13. For example, the discharge hole 19b may be formed in the side portion 13b of the case 13. Outside air may be introduced into the case 13 through the intake hole 19a and then out of the case 13 through the discharge hole 19b, by the blowing force of the fan 18. In the drawings, each of the intake hole 19a and discharge hole 19b is shown to be formed in a plurality, the present disclosure is not limited thereto. There is no limitation on the number of each of the intake holes 19a and the discharge holes 19b.

The cooking apparatus 1 may include a hood 20. The hood 20 may be configured such that air introduced through the intake port 12 flows therethrough. The hood 20 may be configured to guide air introduced through the intake port 12. The hood 20 may be configured to discharge or circulate the air introduced through the intake port 12. The hood 20 may discharge the air introduced through the intake port 12 to the outside of a space in which the cooking apparatus 1 is installed (e.g., outdoors). The hood 20 may circulate the air introduced through the intake port 12 back into the space in which the cooking apparatus 1 is installed (e.g., indoors). In summary, the hood 20 may guide the air introduced through the intake port 12 to the outdoors or indoors.

The hood 20 may be disposed below the plate 11. The hood 20 may be disposed on a lower portion of at least a portion of the cooktop 10. The hood 20 may be disposed below the bottom portion 13a of the case 13. However, the present disclosure is not limited thereto, and the cooktop 10 and the hood 20 may be integrally formed.

By disposing the hood 20 below the cooktop 10, an upper space in which the cooking apparatus 1 is installed may be secured. The upper portion of the cooking apparatus 1 may be provided as an empty space, which may provide cooking space and improve cooking environment.

The hood 20 may include a chamber housing 30. The hood may include a duct 40.

The chamber housing 30 may be disposed on a lower side of the plate 11. The chamber housing 30 may be detachably coupled to a lower portion of at least a portion of the cooktop 10. For example, the chamber housing 30 may be detachably coupled to the bottom portion 13a of the case 13.

The chamber housing 30 may be configured to receive air entering through the intake port 12. The chamber housing 30 may be configured to form a chamber 31 through which air may flow. The chamber 31 may include a flow path for guiding air into a space provided within the chamber housing 30.

Various components may be disposed in the chamber 31. For example, a first filter assembly 60, which will be described later, may be disposed in the chamber 31. For example, a second filter assembly 70, which will be described later, may be disposed in the chamber 31. For example, a fan device 50, which will be described later, may be disposed in the chamber 31. For example, a tray 80, which will be described later, may be disposed in the chamber 31.

The chamber housing 30 may be configured to connect the cooktop 10 and the duct 40. The chamber housing 30 may guide air drawing in through the intake port 12 to the duct 40. For example, the chamber housing 30 may include a chamber discharge portion 35 through which air flows out of the chamber housing 30. The chamber discharge portion 35 may be connected to the duct 40.

The duct 40 may receive air discharged from the chamber housing 30. The duct 40 may guide the air discharged from the chamber housing 30 to the outside or to the space in which the cooking apparatus 1 is installed. For example, one end of the duct 40 may communicate with the chamber discharge portion 35 of the chamber housing 30. For example, the other end of the duct 40 may communicate with the outdoors or indoors. Thus, the duct 40 may discharge the air drawn in through the intake port 12 to the outdoors or circulate the drawn-in air back into the room.

While the chamber housing 30 and the duct 40 are shown in the drawings as separate components, but the present disclosure is not limited thereto. Depending on a variety of factors, including the type of cooktop 10, the installation space, and other factors, the chamber housing 30 and the duct 40 may be provided as an integral configuration.

The cooking apparatus 1 may include the fan device 50. The fan device 50 may be disposed inside the hood 20. While the fan device 50 is shown in the drawings as being accommodated in the chamber housing 30, the present disclosure is not limited thereto. For example, the fan device 50 may be accommodated in the duct 40. For example, the fan device 50 may be provided in one configuration of the hood 20.

The fan device 50 may include a fan 51. The fan 51 may be configured to force air to flow. The fan 51 may generate an intake force. Air may flow into the cooking apparatus 1 through the intake port 12 by the intake force of the fan 51.

The fan device 50 may include a fan motor 53. The fan motor 53 may be configured to drive the fan 51. The fan motor 53 may provide rotational force to the fan 51.

The fan device 50 may include a fan housing 52. The fan housing 52 may be configured to cover the fan 51 and the fan motor 53. The fan housing 52 may be configured to accommodate the fan 51 and the fan motor 53.

The cooking apparatus 1 may include the first filter assembly 60. The first filter assembly 60 may be disposed in the chamber 31. The first filter assembly 60 may be provided at a lower side of the intake port 12.

The first filter assembly 60 may include a first filter unit 61 and a first filter bracket 62 on which the first filter unit 61 is mounted.

The first filter unit 61 may be configured to filter air entering through the intake port 12. For example, the first filter unit 61 may include a grease filter for removing oil particles contained in the air. The first filter unit 61 may have fine holes formed therein to allow air excluding oil particles to pass through.

The first filter unit 61 may be provided in a plurality. Each of the plurality of first filter units 61 may be mounted on the first filter bracket 62. For example, each of the plurality of first filter units 61 may be mounted on both sides of the first filter bracket 62. While two first filter units 61 are shown in the drawings, the present disclosure is not limited thereto. Depending on the sizes and shapes of the first filter unit 61 and the first filter bracket 62, the number of first filter units 61 may be varied.

The first filter bracket 62 may have an upper surface open toward the intake port 12. With such a configuration, the first filter bracket 62 may guide the air entering through the intake port 12 to the first filter unit 61.

The cooking apparatus 1 may include the second filter assembly 70. The second filter assembly 70 may be disposed in the chamber 31. The second filter assembly 70 may be disposed downstream of the first filter assembly 60 along a flow direction of air flow.

The second filter assembly 70 may be arranged on one side of the first filter assembly 60. While only one second filter assembly 70 is shown in the drawings, the present disclosure is not limited thereto. For example, a plurality of second filter assemblies 70 may be provided, and may be provided on both sides of the first filter assembly 60.

The second filter assembly 70 may be disposed between the first filter assembly 60 and the fan device 50. With such a configuration, the air entering through the intake port 12 may pass through the first filter assembly 60 and the second filter assembly 70 and be guided to the duct 40.

The second filter assembly 70 may include a second filter unit 100 and a second filter bracket 71 on which the second filter unit 100 is mounted. The second filter unit 100 and the second filter bracket 71 may be disposed substantially perpendicular to a bottom surface of the chamber housing 30.

The second filter unit 100 may be configured to filter air that has been introduced through the intake port 12 and passed through the first filter unit 61. In other words, the second filter unit 100 may be configured to filter air drawn in from the surroundings of the cooking apparatus 1. For example, the second filter unit 100 may include a deodorizing filter for removing odor particles contained in the air.

The second filter unit 100 may be provided in a plurality. Each of the plurality of second filter units 100 may be mounted on the second filter bracket 71. For example, the plurality of second filter units 100 may be mounted side by side on one side of the second filter bracket 71. While two second filter units 100 are shown in the drawings, the present disclosure is not limited thereto. Depending on the sizes and shapes of the second filter unit 100 and the second filter bracket 71, the number of second filter units 100 may be varied.

The cooking apparatus 1 may include the tray 80. The tray 80 may receive foreign matter, such as powder, crumbs, and water, and the like generated during cooking. The tray 80 may be disposed a lower side of the first filter assembly 60. The tray 80 may be disposed inside the chamber housing 30. For example, the tray 80 may be seated on the bottom surface inside the chamber housing 30. For example, the tray 80 may be provided in one configuration of the hood 20.

The tray 80 may include a handle 81 that is grippable by a user. For example, the user may withdraw the tray 80 from the chamber housing 30 or insert the tray 80 into the chamber housing 30 while grasping the handle 81. For example, the handle 81 may have a shape protruding toward the intake port 12.

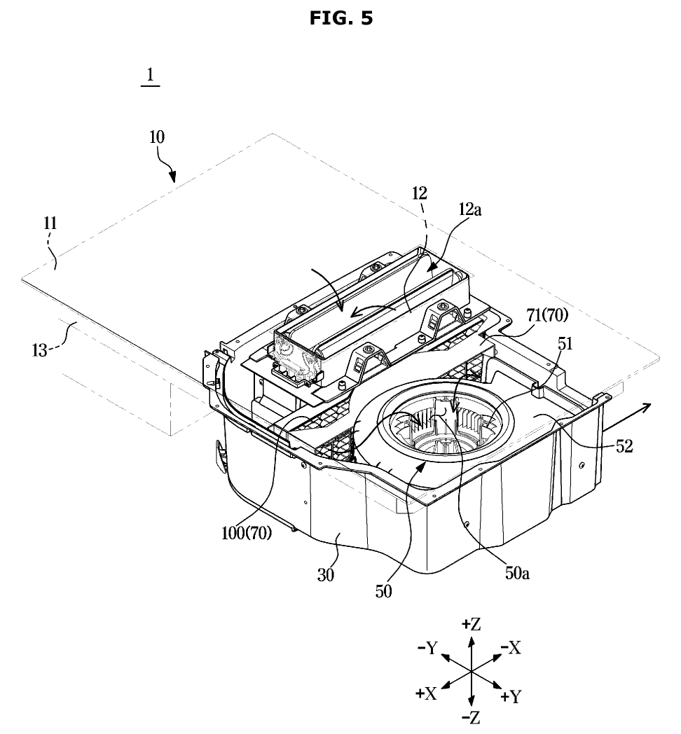

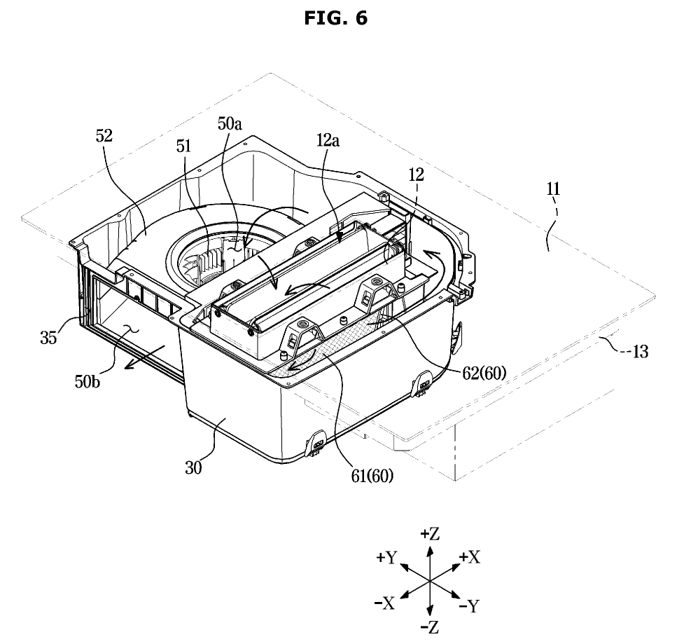

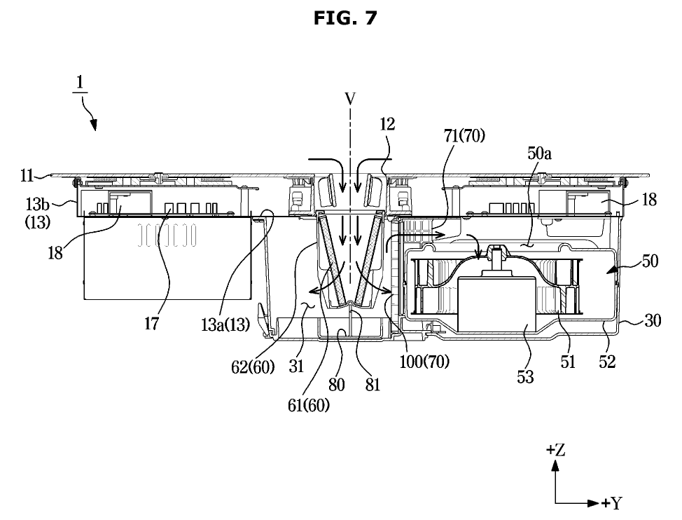

FIG. 5 illustrates a portion of an interior of the cooking apparatus according to an embodiment of the present disclosure. FIG. 6 illustrates a portion of the interior of the cooking apparatus according to an embodiment of the present disclosure. FIG. 7 is a schematic cross-sectional view of the cooking apparatus according to an embodiment of the present disclosure.

The cooking apparatus 1 may include a cover 12a. The cover 12a may be configured to cover or open the intake port 12. The cover 12a may be movably configured to cover or open the intake port 12. The cover 12a may be rotatably configured to cover or open the intake port 12.

An example of air flow will be described with reference to FIGS. 5 to 7. The cover 12a may open the intake port 12. Air may flow into the interior of the cooktop 10 through the intake port 12 opened by the cover 12a. The air introduced through the intake port 12 may flow into the hood 20. The air introduced through the intake port 12 may flow into the chamber housing 30. The air flowing into the chamber housing 30 may pass through the first filter assembly 60. The air that has passed through the first filter assembly 60 may pass through the second filter assembly 70. The air that has passed through the second filter assembly 70 may flow to an inlet side 50a of the fan device 50. Air introduced into the fan device 50 may flow out through an outlet side 50b of the fan device 50. The outlet side 50b of the fan device 50 may be open toward the chamber discharge portion 35 of the chamber housing 30. The air discharged from the fan device 50 may flow out of the chamber housing 30 through the chamber discharge portion 35. The air flowing out of the chamber housing 30 may flow into the duct 40 (see FIGS. 1 to 3). The air introduced into the duct 40 may be discharged to the outdoors or circulated indoors.

In the following, a filter unit according to an embodiment of the present disclosure will be described. The second filter described herein may correspond to the first filter recited in the claims. The third filter described herein may correspond to the second filter recited in the claims.

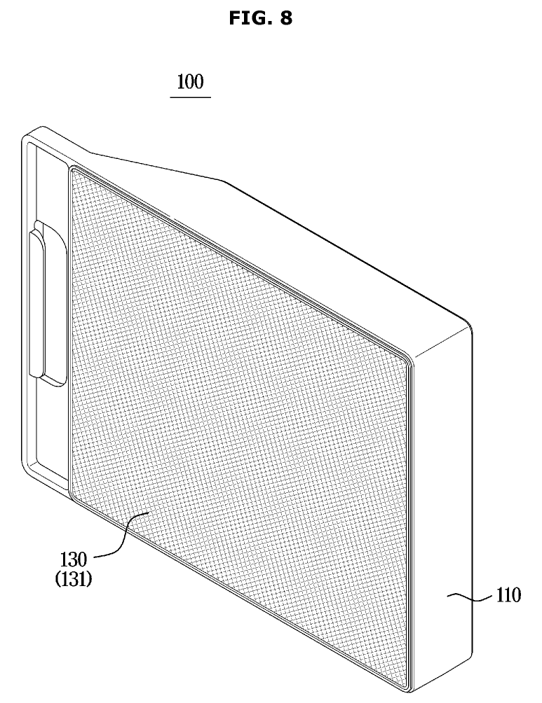

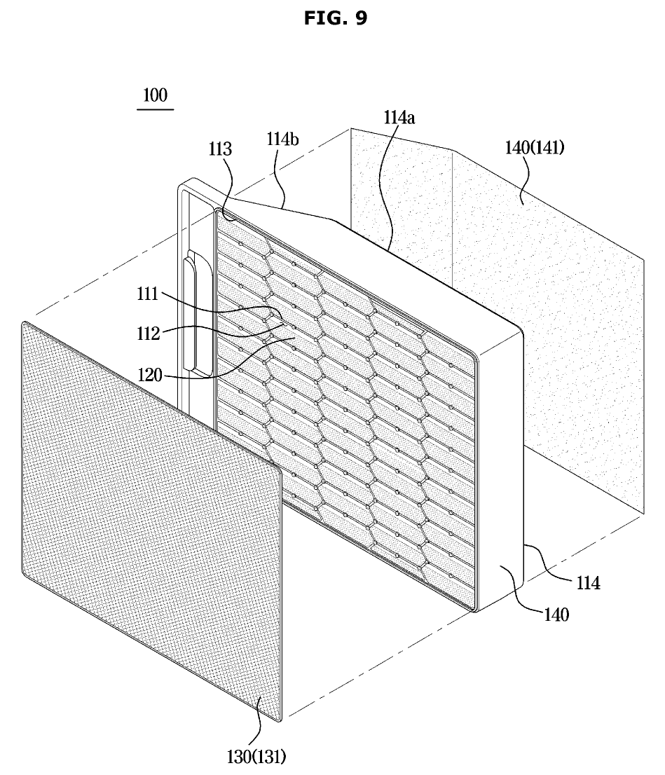

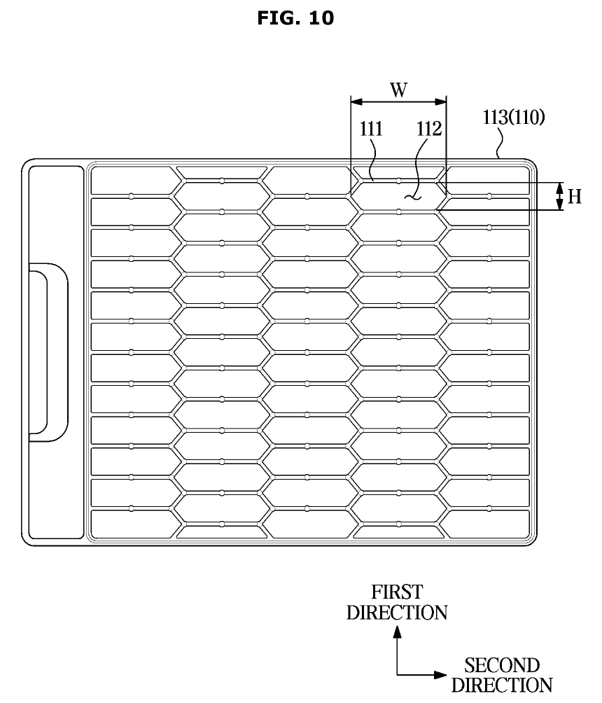

FIG. 8 is a perspective view of a filter unit according to an embodiment of the present disclosure. FIG. 9 is an exploded perspective view illustrating a configuration of the filter unit according to an embodiment of the present disclosure. FIG. 10 is a front view of the filter unit according to an embodiment of the present disclosure.

The second filter unit 100 may include a frame 110. A front surface 113 of the frame 110 may be arranged to face the first filter assembly 60 (see FIGS. 4 to 7). A rear surface 114 of the frame may be arranged to face the fan device 50 (see FIGS. 4 to 7).

The front surface 113 of the frame 110 may be provided to be substantially flat. The rear surface 114 of the frame may include a parallel portion 114a parallel to the front surface 113 and an inclined portion 114b inclined with respect to the parallel portion 114a. Specifically, the rear surface 114 of the frame 110 may include the inclined portion 114b that is inclined with respect to the second direction.

With such a configuration, the second filter unit 100 may be arranged with a predetermined gap between the fan device 50 (see FIGS. 4 to 7) and the inclined portion 114b. This may facilitate mounting the second filter unit 100 inside the chamber 31 (see FIG. 4). Furthermore, the inclined portion 114b may allow air to flow smoothly therethrough.

The frame 110 may include a plurality of cells 111 therein. At least some of the plurality of cells 111 may have the same shape as each other. For example, each of the plurality of cells 111 may have a hexagonal shape.

The plurality of cells 111 may be stacked in a first direction of the frame 110. For example, the plurality of cells 111 may be stacked in a vertical direction of the frame 110. Although the number of the plurality of cells 111 stacked in the first direction of the frame 110 is specified in the drawings, the present disclosure is not limited thereto. There is no limitation on the number of the plurality of cells 111 stacked in the first direction of the frame 110.

The plurality of cells 111 may be arranged in a second direction that intersects the first direction of the frame 110. For example, the plurality of cells 111 may be arranged in a left-to-right direction of the frame 110. Although the number of the plurality of cells 111 arranged in the second direction is specified in the drawings, the present disclosure is not limited thereto. There is no limitation on the number of the plurality of cells 111 arranged in the second direction.

A length along the first direction of each of the plurality of cells 111 may correspond to a height of each of the plurality of cells 111. In other words, a length H along the first direction of each of the plurality of cells 111 may correspond to a distance between an upper end and a lower end of each of the plurality of cells 111.

A length W along the second direction of each of the plurality of cells 111 may correspond to a width of each of the plurality of cells 111. In other words, the length W along the second direction of each of the plurality of cells 111 may correspond to a distance at which both side ends of each of the plurality of cells 111 are separated from each other.

Each of the plurality of cells 111 may have the length H along the first direction shorter than the length W along the second direction. That is, the height of each of the plurality of cells 111 may be shorter than its width. Preferably, for each of the plurality of cells 111, the ratio of the length H along the first direction to the length W along the second direction may be between 1:1.9 and 1:8.7. Preferably, the length H along the first direction of each of the plurality of cells 111 may be 6 mm to 15 mm. Preferably, the length W along the second direction of each of the plurality of cells 111 may be 25 mm to 70 mm.

Each of the plurality of cells 111 may form an opening 112 through which air may pass. With such a configuration, the air introduced from the intake port 12 (see FIG. 7) and passing through the first filter assembly 60 (see FIG. 7) may be filtered as it passes through the second filter unit 100. The opening 112 may extend from the front surface 113 of the frame 110 to the rear surface 114 of the frame 110. In this case, the length over which the opening 112 extends from the front surface 113 of the frame 110 to the rear surface 114 of the frame 110 may be 25 mm to 35 mm. Stated differently, the width of the opening 112 may be 25 mm to 35 mm.

The second filter unit 100 may include a deodorizing agent 120 (e.g., deodorizer). The deodorizing agent 120 may be configured to remove odor from the air. For example, the deodorizing agent 120 may include activated carbon, zeolite, alumina, silica, metal organic frameworks (MOF), or the like.

The deodorizing agent 120 may be provided in the form of a plurality of particles. Each of the plurality of particles may have a size of 3 mm or less in diameter. Preferably, each of the plurality of particles may have a size of 1.5 mm to 3 mm.

The deodorizing agent 120 may be accommodated inside the plurality of cells 111. For example, the deodorizing agent 120 may be accommodated in each of the plurality of cells 111 in the form of a plurality of particles. With such a configuration, the deodorizing agent 120 may remove odor from the air as the air introduced through the intake port 12 passes through the plurality of cells 111.

The air passing through the plurality of cells 111 may be concentrated and flow toward a central portion of each of the plurality of cells 111. Thus, when the deodorizing agent 120 is accommodated in each of the plurality of cells 111, a majority of the air passing through the plurality of cells 111 may encounter the deodorizing agent 120 located in the central portion of each of the plurality of cells 111. On the other hand, the deodorizing agent 120 located at the upper and lower portions of each of the plurality of cells 111 may encounter a relatively small amount of air. As a result, odor removal from the air passing through the plurality of cells 111 may be performed primarily by the deodorizing agent 120 located in the central portion of each of the plurality of cells 111, and very little by the deodorizing agent 120 located at the upper and lower portions of each of the plurality of cells 111. This may result in wasted deodorizing agent 120 and a shorten lifespan of the second filter unit 100.

According to the concept of the present disclosure, each of the plurality of cells 111 may have the length H along the first direction shorter than the length W along the second direction. In other words, the height of each of the plurality of cells 111 may be shorter than its width. With such a configuration, it is possible to prevent the air passing through the plurality of cells 111 from being concentrated and flowing toward the central portion of each of the plurality of cells 111. That is, the air passing through the plurality of cells 111 may flow relatively uniformly inside each of the plurality of cells 111. Accordingly, the deodorizing agent 120 accommodated in each of the plurality of cells 111 may perform deodorization in the air relatively uniformly regardless of its location. As a result, the wasted deodorizing agent 120 may be reduced, and the lifespan of the second filter unit 100 may be extended.

The second filter unit 100 may include a first filter 130.

The first filter 130 may be coupled to the front surface 113 of the frame 110. For example, the first filter 130 may be coupled to the front surface 113 of the frame 110 using a thermal bonding method. However, the bonding method is not limited thereto.

The first filter 130 may be configured to allow air to pass therethrough. The first filter 130 may prevent the deodorizing agent 120 accommodated inside the plurality of cells 111 from escaping from the frame 110. For example, the first filter 130 may include a mesh net 131. The mesh net 131 may allow air to pass through a plurality of pores formed therein but may not allow the particulate deodorizing agent 120 to pass therethrough. Each of the plurality of pores may be provided in an approximately square shape. In this case, one side of each of the plurality of pores may have a length of 0.292 mm or less. However, the present disclosure is not limited thereto.

The second filter unit 100 may include a second filter 140.

The second filter 140 may be coupled to the rear surface 114 of the frame 110. For example, the second filter 140 may be coupled to the rear surface 114 of the frame 110 using an insert injection molding method. However, the coupling method is not limited thereto.

The second filter 140 may be configured to allow air to pass therethrough. The second filter 140 may prevent the deodorizing agent 120 accommodated inside the plurality of cells 111 from escaping from the frame 110. For example, the second filter 140 may include a non-woven fabric 141. The non-woven fabric 141 may be breathable, allowing air to pass therethrough, but not the particulate deodorizing agent 120. The non-woven fabric 141 may be provided to be 50 grams per square meter (gsm) or less. However, the present disclosure is not limited thereto.

According to the concept of the present disclosure, the mesh net 131 may be coupled to the front surface 113 of the frame 110, and the non-woven fabric 141 may be coupled to the rear surface 114 of the frame 110. The mesh net 131 may more smoothly form a flow of air introduced into the second filter unit 100 through the plurality of pores. The non-woven fabric 141 may not be provided with special pores, which may better prevent the deodorizing agent 120 from leaking out.

At least one of the first filter 130 and the second filter 140 may include a flame-retardant material. With such a configuration, the first filter 130 and the second filter 140 may not be easily damaged even though heat is generated by the heating portion 16 (see FIG. 4).

Hereinafter, a method of manufacturing the filter unit according to an embodiment of the present disclosure will be briefly described.

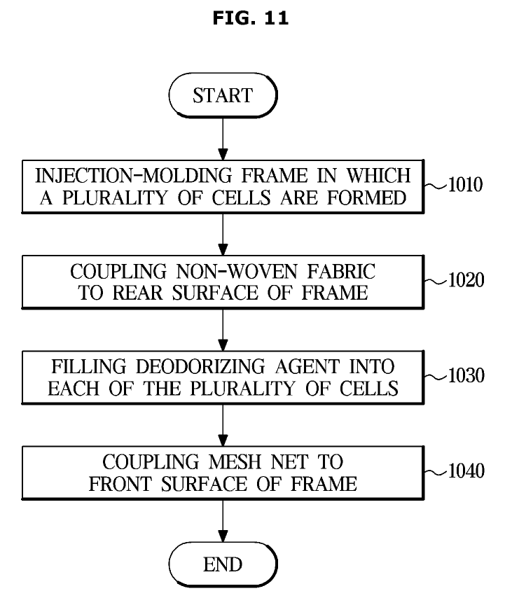

FIG. 11 is a flowchart illustrating a method of manufacturing a filter unit according to an embodiment of the present disclosure.

First, the frame 110 in which the plurality of cells 111 are formed may be injection molded (1010). The plurality of cells 111 may be stacked in the first direction. The plurality of cells 111 may be arranged in the second direction. Each of the plurality of cells 111 may have the length H along the first direction shorter than the length W along the second direction.

During the injection molding of the frame 110 (1010), the non-woven fabric 141 may be inserted to couple the non-woven fabric 141 to the rear surface 114 of the frame 110 (1020). By inserting the non-woven fabric 141 into the rear surface 114 of the frame 110, the frame 110 and the non-woven fabric 141 may be integrally coupled.

Each of the plurality of cells 111 may then be filled with the deodorizing agent 120 (1030). The deodorizing agent 120 may be configured to remove odor from the air. The deodorizing agent 120 may be provided in the form of a plurality of particles, which may be filled into each of the plurality of cells 111.

Thereafter, the mesh net 131 may be coupled to the front surface 113 of the frame 110 using a thermal fusion method.

In the following, other embodiments of the present disclosure will be described. Since other configurations, except for the plurality of cells, are the same as those of the embodiment described above, redundant descriptions will be omitted.

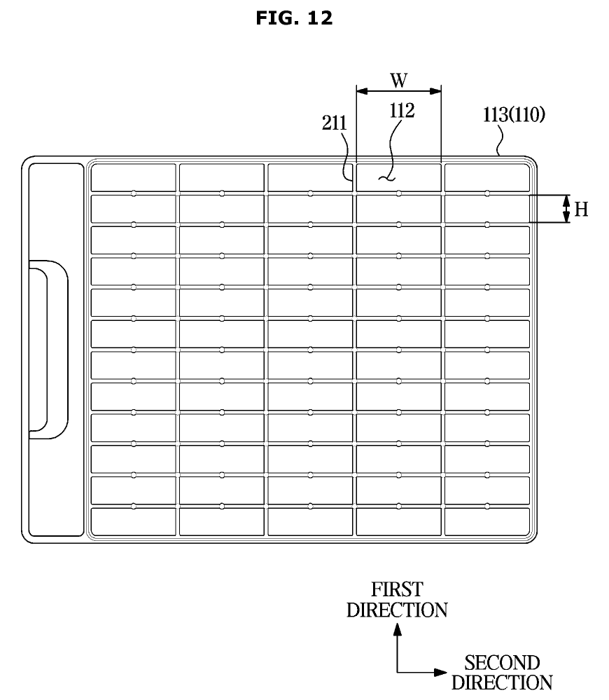

FIG. 12 is a front view of a filter unit according to an embodiment of the present disclosure.

Referring to FIG. 12, each of the plurality of cells 211 may have a rectangular shape. Each of the plurality of cells 211 may be stacked in the first direction of the frame 110. Each of the plurality of cells 211 may be arranged in the second direction intersecting the first direction of the frame 110. Each of the plurality of cells 211 may have the length H along the first direction shorter than the length W along the second direction. Preferably, for each of the plurality of cells 211, the ratio of the length H along the first direction to the length W along the second direction may be 1:1.9 to 1:8.7.

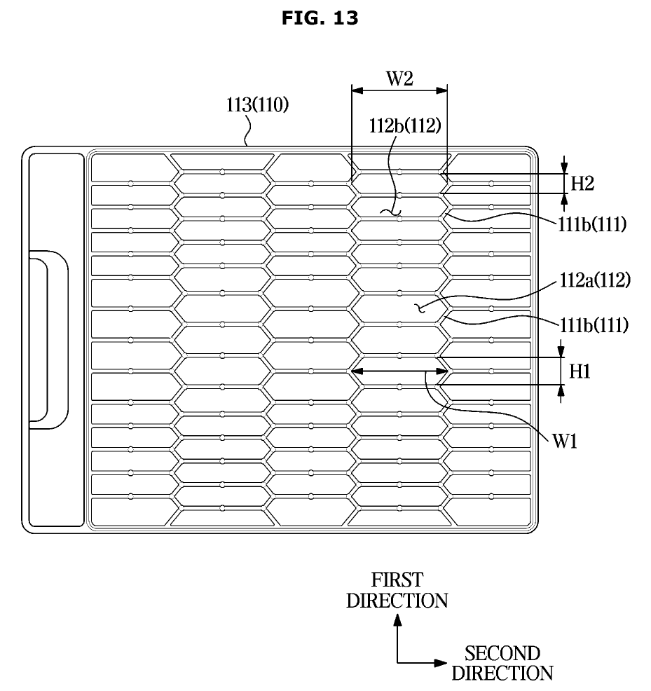

FIG. 13 is a front view of a filter unit according to an embodiment of the present disclosure.

Referring to FIG. 13, the plurality of cells 111 may include a plurality of first cells 111a and a plurality of second cells 111b. Each of the plurality of first cells 111a may form a first opening 112a. Each of the plurality of second cells 111b may form a second opening 112b.

The first opening 112a may have a size larger than that of the second opening 112b. Specifically, the first opening 112a may have a height greater than that of the second opening 112b. In this case, the first opening 112a may have a width equal to a width of the second opening 112b.

In other words, a length H1 along the first direction of each of the plurality of first cells 111a may be longer than a length H2 along the first direction of each of the plurality of second cells 111b. In this case a length W1 along the second direction of each of the plurality of first cells 111a may be the same as a length W2 along the second direction of each of the plurality of second cells 111b.

Positions at which the plurality of first cells 111a and the plurality of second cells 111b are arranged in the frame 110 may be different from each other. In other words, the size of the opening 112 formed by the plurality of cells 111 may vary depending on the positions at which the plurality of cells 111 are arranged in the frame 110.

Air passing through the openings 112 may undergo resistance due to a pressure difference between the front end and the rear end of the opening 112. In this case, the resistance experienced by the air may vary depending on the size of the opening 112. The greater the amount of resistance the air encounters, the less the amount of air may pass through the opening 112. For example, when the size of the opening 112 is large, the resistance encountered by the air may be less than when the size of the opening 112 is small, and relatively more amount of air may flow therethrough.

The plurality of first cells 111a may be disposed at a central portion of the frame 110. The plurality of second cells 111b may be disposed at upper and lower portions of the frame 110. With such a configuration, air passing through the central portion of the frame 110 may encounter less resistance than air passing through the upper and lower portions of the frame 110.

Air introduced into the frame 110 may be more concentrated in the upper and lower portions of the frame 110 than in the central portion of the frame 110. Due to the difference in the size of the openings 112, the resistance encountered by the air introduced into the upper and lower portions of the frame 110 may be greater than the resistance encountered by the air introduced into the central portion of the frame 110. Thus, the amount of air passing through the upper and lower portions of the frame 110 may be reduced, and the amount of air passing through the central portion of the frame 110 may be increased. As a result, the air that is concentratedly introduced into the upper and lower portions of the frame 110 may flow uniformly through the entire area of the frame 110.

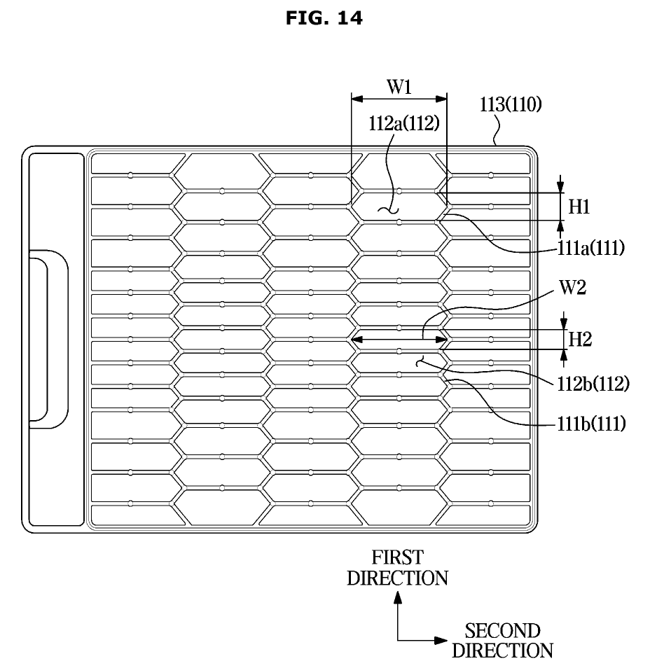

FIG. 14 is a front view of a filter unit according to an embodiment of the present disclosure.

The plurality of first cells 111a may be disposed at the upper and lower portions of the frame 110. The plurality of second cells 111b may be disposed at the central portion of the frame 110. With such a configuration, air passing through the upper and lower portions of the frame 110 may encounter less resistance than air passing through the central portion of the frame 110.

Air introduced into the frame 110 may be more concentrated in the central portion than in the upper and lower portions of the frame 110. Due to the difference in the size of the opening 112, the resistance encountered by the air introduced into the central portion of the frame 110 may be greater than the resistance encountered by the air introduced into the upper and lower portions of the frame 110. Thus, the amount of air passing through the central portion of the frame 110 may be reduced, and the amount of air passing through the upper and lower portions of the frame 110 may be increased. As a result, the air that is concentratedly introduced into the central portion of the frame 110 may flow uniformly through the entire area of the frame 110.

The cooking apparatus 1 according to the concept of the present disclosure may include the plate 11 including the cooking zone 11a and the intake port 12 formed to draw in air surrounding the cooking zone 11a. In addition, the cooking apparatus may include the chamber housing 30 disposed on a lower side of the plate 11 and forming the chamber 31 through which air flows. In addition, the cooking apparatus may include the second filter unit 100 disposed in the chamber 31 and configured to filter air introduced through the intake port 12. The second filter unit 100 may include the frame 110 including the plurality of cells 111 and the deodorizing agent 120 accommodated inside the plurality of cells 111. The plurality of cells 111 may be stacked in a first direction of the frame 110 and arranged in a second direction intersecting the first direction. Each of the plurality of cells 111 may have the length H along the first direction shorter than the length W along the second direction.

Each of the plurality of cells 111 may form the opening 112 to allow air to pass therethrough.

The plurality of cells 111 may include the plurality of first cells 111a and the plurality of second cells 111b. Each of the plurality of first cells 111a may form the first opening 112a, and each of the plurality of second cells 111b may form the second opening 112b. The first opening 112a may have a size larger than that of the second opening 112b.

The length H1 along the first direction of each of the plurality of first cells 111a may be longer than the length H2 along the first direction of each of the plurality of second cells 111b.

The plurality of first cells 111a may be arranged in a central portion of the frame 110, and the plurality of second cells 111b may be arranged in an upper portion and a lower portion of the frame 110.

The plurality of first cells 111a may be arranged in an upper portion and a lower portion of the frame 110, and the plurality of second cells 111b may be arranged in a central portion of the frame 110.

For each of the plurality of cells 111, the ratio of the length H along the first direction to the length W along the second direction may be in a range of 1:1.9 and 1:8.7.

Each of the plurality of cells 111 may have the length H along the first direction of 6 mm to 15 mm, and the length W along the second direction of 25 mm to 70 mm.

The second filter unit 100 may further include the first filter 130 coupled to the front surface 113 of the frame 110 and the second filter 140 coupled to the rear surface 114 of the frame 110.

At least one of the first filter 130 and the second filter 140 may include a flame-retardant material.

The first filter 130 may include the mesh net 131, and the second filter 140 may include the non-woven fabric 141.

Each of the plurality of cells 111 may have a hexagonal shape.

Each of the plurality of cells 211 may have a rectangular shape.

The rear surface 114 of the frame 110 may include the parallel portion 114a parallel to the front surface 113 of the frame 110, and the inclined portion 114b inclined with respect to the parallel portion 114a.

The inclined portion 114b may be formed to be inclined with respect to the second direction.

The cooking apparatus 1 according to the concept of the present disclosure may include the plate 11 including the intake port 12 and the second filter unit 100 disposed below the plate 11 and configured to filter air entering through the intake port 12. The second filter unit 100 may include the frame 110 including the plurality of cells 111, the first filter 130 coupled to the front surface 113 of the frame 110, and the second filter 140 coupled to the rear surface 114 of the frame 110. The plurality of cells 111 may be stacked in a first direction of the frame 110 and arranged in a second direction intersecting the first direction. Each of the plurality of cells 111 may have the length H along the first direction shorter than the length W along the second direction.

The second filter unit 100 may further include the deodorizing agent 120 for removing odor from the air entering through the intake port 12, and the deodorizing agent 120 may be provided in the form of a plurality of particles, wherein the diameter of each of the plurality of particles may be 1.5 mm to 3 mm.

The deodorizing agent 120 may be accommodated in each of the plurality of cells 111.

For each of the plurality of cells 111, the ratio of the length H along the first direction to the length W along the second direction may be from 1:1.9 to 1:8.7.

A manufacturing method of the second filter unit 100 according to the concept of the present disclosure may include: injection-molding the frame 110 in which the plurality of cells 111 are formed (1010); inserting the non-woven fabric 141 during the injection molding of the frame 110 to couple the non-woven fabric 141 to the rear surface 114 of the frame 110 (1020); filling the deodorizing agent 120 into each of the plurality of cells 111 (1030); and coupling the mesh net 131 to the front surface 113 of the frame 110 using a thermal fusion method (1040). The second filter unit 100 may be provided inside the cooking apparatus 1 to filter air introduced from the surroundings of the cooking apparatus 1.

According to the concept of the present disclosure, the performance of the filter unit may be improved by increasing the contact rate of the air flow with the deodorizer.

According to the concept of the present disclosure, the lifespan of the filter unit may be extended by minimizing the wasted deodorizer.

The effects to be obtained in the present disclosure are not limited to the above-mentioned effects, and other effects not mentioned will be clearly understood by those skilled in the art to which the present disclosure pertains from the following description.

While the present disclosure has been particularly described with reference to exemplary embodiments, it should be understood by those of skilled in the art that various changes in form and details may be made without departing from the spirit and scope of the present disclosure.

1. A cooking apparatus, comprising:
a plate including a cooking zone and an intake port to allow air to be introduced toward the cooking zone;
a chamber housing, to disposed on a lower side of the plate, forming a chamber through which the air flows; and
a filter unit, to be disposed in the chamber, configured to filter the air introduced through the intake port;
wherein the filter unit comprises:
a frame that allows a plurality of cells to be stacked along a first direction of the frame and be arranged along a second direction of the frame intersecting the first direction, and
a deodorizing agent to be accommodated inside the plurality of cells, and
wherein the plurality of cells respectively have a length along the first direction shorter than a length along the second direction.

2. The cooking apparatus of claim 1, wherein respective cells among the plurality of cells form an opening to allow air to pass therethrough.

3. The cooking apparatus of claim 2, wherein
the respective cells among the plurality of cells are a plurality of first cells and the plurality of cells include a plurality of second cells,
the plurality of first cells respectively form a first opening,
the plurality of second cells respectively form a second opening, and
the first opening has a size larger than that of the second opening.

4. The cooking apparatus of claim 3, wherein a length along the first direction of each of the plurality of first cells is longer than a length along the first direction of each of the plurality of second cells.

5. The cooking apparatus of claim 3, wherein
the plurality of first cells are arranged in a central portion of the frame, and
the plurality of second cells are arranged in an upper portion and a lower portion of the frame.

6. The cooking apparatus of claim 3, wherein
the plurality of first cells are arranged in an upper portion and a lower portion of the frame, and
the plurality of second cells are arranged in a central portion of the frame.

7. The cooking apparatus of claim 1, wherein, for each of the plurality of cells, the ratio of the length along the first direction to the length along the second direction is between 1:1.9 and 1:8.7.

8. The cooking apparatus of claim 1, wherein the plurality of cells respectively have:
a length along the first direction of 6 mm to 15 mm, and
a length along the second direction of 25 mm to 70 mm.

9. The cooking apparatus of claim 1, wherein the filter unit further comprises:
a first filter coupled to a front surface of the frame, and
a second filter coupled to a rear surface of the frame.

10. The cooking apparatus of claim 9, wherein at least one of the first filter and the second filter comprises a flame-retardant material.

11. The cooking apparatus of claim 9, wherein
the first filter comprises a mesh net, and
the second filter comprises a non-woven fabric.

12. The cooking apparatus of claim 1, wherein the plurality of cells respectively have a hexagonal shape.

13. The cooking apparatus of claim 1, wherein the plurality of cells respectively a rectangular shape.

14. The cooking apparatus of claim 1, wherein a rear surface of the frame comprises:
a parallel portion parallel to a front surface of the frame, and
an inclined portion inclined with respect to the parallel portion.

15. The cooking apparatus of claim 14, wherein the inclined portion is inclined with respect to the second direction.
